(19) United States
(12) Patent Application Publication
(10) Pub. No.: US 2017/0313942 A1
(43) Pub. Date: Nov. 2, 2017

(54) Mixtures Of Diphosphinic Acids And Dialkylphosphinic Acids, A Process For The Preparation Thereof And The Use Thereof

(71) Applicant: Clariant International Ltd., Muttenz (CH)

(72) Inventors: Fabian SCHNEIDER, Eppelheim (DE); Frank OSTEROD, Köln (DE); Harald BAUER, Kerpen (DE); Martin SICKEN, Köln (DE)

(73) Assignee: Clariant International Ltd., Muttenz (CH)

(21) Appl. No.: 15/653,112

(22) Filed: Jul. 18, 2017

Related U.S. Application Data
(62) Division of application No. 14/364,851, filed on Jun. 12, 2014.

(30) Foreign Application Priority Data
Dec. 16, 2011 (DE) 10 2011 121 503.8

(51) Int. Cl. C09K 21/12; C07F 9/30; C08K 5/5313

(52) U.S. Cl. CPC C09K 21/12; C08K 5/5313; C07F 9/301; C07F 9/305; C08K 2201/014

(57) ABSTRACT

The invention relates to mixtures of at least one diphosphinic acid of the formula (I)

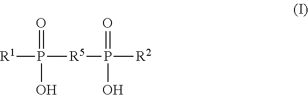

in which
R¹, R² are the same or different and are each independently H, C₁-C₁₈-alkyl, C₂-C₁₈-alkenyl, C₆-C₁₈-aryl, C₇-C₁₈-alkylaryl,
R⁵ is C₁-C₁₈-alkylene, C₂-C₁₈-alkenylene, C₆-C₁₈-arylene, C₇-C₁₈-alkylarylene
with at least one dialkylphosphinic acid of the formula (II)

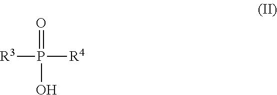

in which
R³, R⁴ are the same or different and are each independently C₁-C₁₈-alkyl, C₂-C₁₈-alkenyl, C₆-C₁₈-aryl and/or C₇-C₁₈-alkylaryl.

The invention also relates to a process for preparing these mixtures and to the use thereof.

The invention relates to mixtures of at least one diphosphinic acid and at least one dialkylphosphinic acid, to a process for preparation thereof and to the use thereof.

In the production of printed circuit boards, which are being used to an increasing degree in various devices, for example computers, cameras, cellphones, LCD and TFT screens and other electronic devices, different materials, especially polymers, are being used. These include particularly thermosets, glass fiber-reinforced thermosets and thermoplastics. Owing to their good properties, epoxy resins are used particularly frequently.

According to the relevant standards (IPC-4101, Specification for Base Materials for Rigid and Multilayer Printed Boards), these printed circuit boards must be rendered flame-retardant.

The thermal expansion of printed circuit boards in the course of production thereof is a problem. The conditions of electronics manufacture for printed circuit boards require that printed circuit boards withstand high thermal stresses without damage or deformation. The application of conductor tracks (lead-free soldering) to printed circuit boards is effected at temperatures up to about 260° C.

It is therefore important that printed circuit boards do not warp under thermal stress and the products remain dimensionally stable.

Thermal expansion is significant particularly even in the case of prepregs (short form of “preimpregnated fibers”) and laminates, since these constitute the initial forms or precursors of printed circuit boards.

It is thus important to minimize the thermal expansion of test specimens in order to obtain a good, dimensionally stable product (finished printed circuit board).

It is an object of the present invention to modify polymers for prepregs, printed circuit boards and laminates such that they are subject only to very low thermal expansion—if any at all—and dimensional stability is fulfilled.

This object is achieved by mixtures of at least one diphosphinic acid of the formula (I)

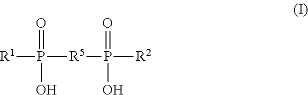

in which
R¹, R² are the same or different and are each independently H, C₁-C₁₈-alkyl, C₂-C₁₈-alkenyl, C₆-C₁₈-aryl, C₇-C₁₈-alkylaryl,
R⁵ is C₁-C₁₈-alkylene, C₂-C₁₈-alkenylene, C₆-C₁₈-arylene, C₇-C₁₈-alkylarylene
with at least one dialkylphosphinic acid of the formula (II)

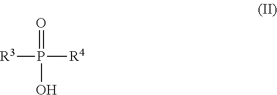

in which
R³, R⁴ are the same or different and are each independently C₁-C₁₈-alkyl, C₂-C₁₈-alkenyl, C₆-C₁₈-aryl and/or C₇-C₁₈-alkylaryl.

Preferably, R¹, R² are the same or different and are each H, methyl, ethyl, n-propyl, isopropyl, n-butyl, isobutyl, tert-butyl, n-pentyl, isopentyl, n-hexyl, isohexyl and/or phenyl; R³, R⁴ are the same or different and, independently of R¹ and R², are each methyl, ethyl, n-propyl, isopropyl, n-butyl, isobutyl, tert-butyl, n-pentyl, isopentyl, n-hexyl, isohexyl and/or phenyl, and R⁵ is ethylene, butylene, hexylene or octylene.

More preferably, R¹, R², R³ and R⁴ are the same or different and are each ethyl and/or butyl, and R⁵ is ethylene or butylene.

The mixtures preferably comprise 0.1 to 99.9% by weight of diphosphinic acid of the formula (I) and 99.9 to 0.1% by weight of dialkylphosphinic acid of the formula (II).

The mixtures preferably also comprise 60 to 99.9% by weight of diphosphinic acid of the formula (I) and 40 to 0.1% by weight of dialkylphosphinic acid of the formula (II).

Preference is also given to mixtures comprising 80 to 99.9% by weight of diphosphinic acid of the formula (I) and 20 to 0.1% by weight of dialkylphosphinic acid of the formula (II).

Particular preference is given to mixtures comprising 90 to 99.9% by weight of diphosphinic acid of the formula (I) and 10 to 0.1% by weight of dialkylphosphinic acid of the formula (II).

Especially preferred are mixtures comprising 95 to 99.9% by weight of diphosphinic acid of the formula (I) and 5 to 0.1% by weight of dialkylphosphinic acid of the formula (II).

Very preferred are mixtures comprising 98 to 99.9% by weight of diphosphinic acid of the formula (I) and 2 to 0.1% by weight of dialkylphosphinic acid of the formula (II).

Preferably, the diphosphinic acid is ethylene-1,2-bis(ethylphosphinic acid), ethylene-1,2-bis(propylphosphinic acid), ethylene-1,2-bis(butylphosphinic acid), ethylene-1,2-bis(pentylphosphinic acid), ethylene-1,2-bis(hexylphosphinic acid), butane-1,2-bis(ethylphosphinic acid), butane-1,2-bis(propylphosphinic acid), butane-1,2-bis(butylphosphinic acid), butane-1,2-bis(pentylphosphinic acid), butane-1,2-bis(hexylphosphinic acid), hexane-1,2-bis(ethylphosphinic acid), hexane-1,2-bis(propylphosphinic acid), hexane-1,2-bis(butylphosphinic acid), hexane-1,2-bis(pentylphosphinic acid) or hexane-1,2-bis(hexylphosphinic acid), and the dialkylphosphinic acid is diethylphosphinic acid, dipropylphosphinic acid, dibutylphosphinic acid, dipentylphosphinic acid or dihexylphosphinic acid.

The preferred mixtures comprise 98 to 99.9% by weight of ethylene-1,2-bis(ethylphosphinic acid) and 2 to 0.1% by weight of diethylphosphinic acid.

The mixtures preferably further comprise at least one synergist.

The synergist is preferably a nitrogen-containing compound such as melem, melam, melon, melamine borate, melamine cyanurate, melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphate, melam polyphosphate, melem polyphosphate and/or melon polyphosphate;
aluminum compounds such as aluminum hydroxide, halloysite, sapphire products, boehmite, nanoboehmite;
magnesium compounds such as magnesium hydroxide;
tin compounds such as tin oxides;
antimony compounds such as antimony oxides;
zinc compounds such as zinc oxide, zinc hydroxide, zinc oxide hydrate, zinc carbonate, zinc stannate, zinc hydroxystannate, zinc silicate, zinc phosphate, zinc borophosphate, zinc borate and/or zinc molybdate;
silicon compounds such as silicates and/or silicones;
phosphorus compounds such as phosphinic acids and salts thereof, phosphonic acids and salts thereof and/or phosphine oxides, phosphazenes and/or piperazine (pyro)phosphates;
carbodiimides, piperazines, (poly)isocyanates, styrene-acrylic polymers and/or carbonylbiscaprolactam;
nitrogen compounds from the group of oligomeric esters of tris(hydroxyethyl) isocyanurate with aromatic polycarboxylic acids, or benzoguanamine, acetoguanamine, tris(hydroxyethyl) isocyanurate, allantoin, glycoluril, cyanurates, cyanurate-epoxide compounds, urea cyanurate, dicyanamide, guanidine, guanidine phosphate and/or sulfate.

The mixtures preferably comprise 99 to 1% by weight of mixture of at least one diphosphinic acid of the formula (I) and at least one dialkylphosphinic acid of the formula (II) as claimed in at least one of claims 1 to 11 and 1 to 99% by weight of synergist.

The invention also relates to a process for preparing the mixtures as claimed in at least one of claims 1 to 11, which comprises reacting a phosphinic acid source with an alkyne in the presence of an initiator.

Preferably, the phosphinic acid source is ethylphosphinic acid and the alkyne is acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene and/or diphenylacetylene and the initiator is a free-radical initiator having a nitrogen-nitrogen or an oxygen-oxygen bond and the reaction temperature is between 50 and 150° C.

The free-radical initiator is preferably 2,2′-azobis(2-amidinopropane) dihydrochloride, 2,2′-azobis(N,N′-dimethyleneisobutyramidine) dihydrochloride, azobis(isobutyronitrile), 4,4′-azobis(4-cyanopentanoic acid) and/or 2,2′-azobis(2-methylbutyronitrile) or hydrogen peroxide, ammonium peroxodisulfate, potassium peroxodisulfate, dibenzoyl peroxide, di-tert-butyl peroxide, peracetic acid, diisobutyryl peroxide, cumene peroxyneodecanoate, tert-butyl peroxyneodecanoate, tert-butyl peroxypivalate, tert-amyl peroxypivalate, dipropyl peroxydicarbonate, dibutyl peroxydicarbonate, dimyristyl peroxydicarbonate, dilauroyl peroxide, 1,1,3,3-tetramethylbutyl peroxy-2-ethylhexanoate, tert-amyl peroxy-2-ethylhexylcarbonate, tert-butyl peroxyisobutyrate, 1,1-di(tert-butylperoxy)cyclohexane, tert-butyl peroxybenzoate, tert-butyl peroxyacetate, tert-butyl peroxydiethylacetate, tert-butyl peroxyisopropylcarbonate, 2,2-di(tert-butylperoxy)butane, tert-amyl hydroperoxide and/or 2,5-dimethyl-2,5-di(tert-butylperoxy)hexane.

The solvent preferably comprises straight-chain or branched alkanes, alkyl-substituted aromatic solvents, water-immiscible or only partly water-miscible alcohols or ethers, water and/or acetic acid.

The alcohol is preferably methanol, propanol, i-butanol and/or n-butanol or comprises mixtures of these alcohols with water.

The invention also relates to the use of mixtures of at least one diphosphinic acid of the formula (I) and at least one dialkylphosphinic acid of the formula (II) as claimed in at least one of claims 1 to 11 as an intermediate for further syntheses, as a binder, as a crosslinker or accelerator in the curing of epoxy resins, polyurethanes and unsaturated polyester resins, as polymer stabilizers, as crop protection compositions, as sequestrants, as a mineral oil additive, as an anticorrosive, in washing and cleaning composition applications and in electronics applications.

The invention additionally relates to the use of mixtures of at least one diphosphinic acid of the formula (I) and at least one dialkylphosphinic acid of the formula (II) as claimed in at least one of claims 1 to 13 as a flame retardant, especially as a flame retardant for clearcoats and intumescent coatings, as a flame retardant for wood and other cellulosic products, as a reactive and/or nonreactive flame retardant for polymers, for production of flame-retardant polymer molding compositions, for production of flame-retardant polymer moldings and/or for rendering polyester and pure and blended cellulose fabrics flame-retardant by impregnation, and as a synergist.

The invention also relates to a flame-retardant thermoplastic or thermoset polymer molding composition and to polymer moldings, films, filaments and fibers comprising 0.5 to 45% by weight of mixtures as claimed in at least one of claims 1 to 13, 55 to 99.5% by weight of thermoplastic or thermoset polymer or mixtures thereof, 0 to 55% by weight of additives and 0 to 55% by weight of filler or reinforcing materials, where the sum of the components is 100% by weight.

The invention finally also relates to a flame-retardant thermoplastic or thermoset polymer molding composition and to polymer moldings, films, filaments and fibers comprising 2 to 30% by weight of mixtures as claimed in at least one of claims 1 to 13, 60 to 94% by weight of thermoplastic or thermoset polymer or mixtures thereof, 2 to 30% by weight of additives and 2 to 30% by weight of filler or reinforcing materials, where the sum of the components is 100% by weight.

Preferred mixtures of diphosphinic acid of the formula (I) and dialkylphosphinic acid of the formula (II) are, for example: ethylene-1,2-bis(ethylphosphinic acid) and diethylphosphinic acid, ethylene-1,2-bis(ethylphosphinic acid) and butylethylphosphinic acid, ethylene-1,2-bis(ethylphosphinic acid) and butylbutylphosphinic acid, ethylene-1,2-bis(ethylphosphinic acid) and hexylethylphosphinic acid, ethylene-1,2-bis(ethylphosphinic acid) and octylethylphosphinic acid, ethylene-1,2-bis(ethylphosphinic acid) and hexylbutylphosphinic acid, ethylene-1,2-bis(butylphosphinic acid) and diethylphosphinic acid, ethylene-1,2-bis(butylphosphinic acid) and butylethylphosphinic acid, ethylene-1,2-bis(butylphosphinic acid) and butylbutylphosphinic acid, ethylene-1,2-bis(butylphosphinic acid) and hexylethylphosphinic acid, ethylene-1,2-bis(butylphosphinic acid) and octylethylphosphinic acid, ethylene-1,2-bis(butylphosphinic acid) and hexylbutylphosphinic acid, butylene-1,2-bis(ethylphosphinic acid) and diethylphosphinic acid, butylene-1,2-bis(ethylphosphinic acid) and butylethylphosphinic acid, butylene-1,2-bis(ethylphosphinic acid) and butylbutylphosphinic acid, butylene-1,2-bis(ethylphosphinic acid) and hexylethylphosphinic acid, butylene-1,2-bis(ethylphosphinic acid) and octylethylphosphinic acid, butylene-1,2-bis(ethylphosphinic acid) and hexylbutylphosphinic acid, butylene-1,2-bis(butylphosphinic acid) and diethylphosphinic acid, butylene-1,2-bis(butylphosphinic acid) and butylethylphosphinic acid, butylene-1,2-bis(butylphosphinic acid) and butylbutylphosphinic acid, butylene-1,2-bis(butylphosphinic acid) and hexylethylphosphinic acid, butylene-1,2-bis(butylphosphinic acid) and octylethylphosphinic acid, butylene-1,2-bis(butylphosphinic acid) and hexylbutylphosphinic acid.

The aforementioned compounds may also take the form of multicomponent mixtures.

Preferred three-component mixtures are, for instance, ethylene-1,2-bis(ethylphosphinic acid) and diethylphosphinic acid and butylethylphosphinic acid, ethylene-1,2-bis(ethylphosphinic acid) and butylethylphosphinic acid and butylbutylphosphinic acid, butylene-1,2-bis(ethylphosphinic acid) and diethyiphosphinic acid and butylethylphosphinic acid, ethylene-1,2-bis(ethylphosphinic acid) and butylene-1,2-bis(ethylphosphinic acid) and diethylphosphinic acid, etc.

Preferred mixtures of 4 components are, for instance, ethylene-1,2-bis(ethylphosphinic acid) and butylene-1,2-bis(ethylphosphinic acid) and diethylphosphinic acid and butylethylphosphinic acid, etc.

Preference is also given to mixtures consisting of 98 to 99.9% by weight of ethylene-1,2-bis(ethylphosphinic acid) and 2 to 0.1% by weight of diethylphosphinic acid.

The synergist is preferably at least one expansion-neutral substance. The expansion-neutral substance prevents the expansion of the polymer or reduces it to extremely low values.

Preferred mixtures with one or more synergists are those comprising 99 to 50% by weight of mixtures as claimed in at least one of claims 1 to 11 and 1 to 50% by weight of synergist.

Preference is given to processing the inventive mixture of at least one diphosphinic acid of the formula (I) and at least one dialkylphosphinic acid of the formula (II) by mixing it into a polymer system.

The mixing is effected by kneading, dispersing and/or extruding.

Particular preference is given to processing the inventive mixture of at least one diphosphinic acid of the formula (I) and at least one dialkylphosphinic acid of the formula (II) by reactive incorporation into a polymer system. Reactive incorporation is characterized by a resulting permanent bond to the polymer extrudates of the polymer system, as a result of which the inventive mixture of at least one diphosphinic acid of the formula (I) and at least one dialkylphosphinic acid of the formula (II) cannot be leached out of the polymer.

Preference is also given to using the inventive mixture of at least one diphosphinic acid of the formula (I) and at least one dialkylphosphinic acid of the formula (II) by additive incorporation into a polymer system.

The inventive mixtures of at least one diphosphinic acid of the formula (I) and at least one dialkylphosphinic acid of the formula (II) can be used with further flame retardants and further synergists. The further flame retardants include, for example, phosphorus compounds such as phosphinates, phosphonates, phosphates, phosphonic acids, phosphinic acids, phosphoric acids, phosphines, phosphine oxides, phosphorus oxides and others.

Suitable polymer additives for flame-retardant polymer molding compositions and polymer moldings are UV absorbers, light stabilizers, lubricants, colorants, antistats, nucleating agents, fillers, synergists, reinforcers and others.

The polymer systems preferably originate from the group of the thermoplastic polymers such as polyamide, polyester or polystyrene and/or the thermoset polymers.

The thermoset polymers are more preferably epoxy resins.

The thermoset polymers are more preferably epoxy resins which have been cured with phenols and/or dicyandiamide [more generally: phenol derivatives (resols); alcohols and amines, especially phenol derivatives and dicyandiamide].

The thermoset polymers are more preferably epoxy resins which have been cured with phenols and/or dicyandiamide and/or a catalyst.

The catalysts are preferably imidazole compounds.

The epoxy resins are preferably polyepoxide compounds.

The epoxy resins preferably originate from the group of the novolacs and the bisphenol A resins.

The polymers are preferably polymers of mono- and diolefins, for example polypropylene, polyisobutylene, polybutene-1, poly-4-methylpentene-1, polyisoprene or polybutadiene, and addition polymers of cycloolefins, for example of cyclopentene or norbornene; and also polyethylene (which may optionally be crosslinked), e.g. high-density polyethylene (HDPE), high-density high-molar mass polyethylene (HDPE-HMW), high-density ultrahigh-molar mass polyethylene (HDPE-UHMW), medium-density polyethylene (MDPE), low-density polyethylene (LDPE), linear low-density polyethylene (LLDPE), branched low-density polyethylene (BLDPE), and mixtures thereof.

The polymers are preferably copolymers of mono- and diolefins with one another or with other vinyl monomers, for example ethylene-propylene copolymers, linear low-density polyethylene (LLDPE) and mixtures thereof with low-density polyethylene (LDPE), propylene-butene-1 copolymers, propylene-isobutylene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene such as hexadiene, dicyclopentadiene or ethylidenenorbornene; and also mixtures of such copolymers with one another, e.g. polypropylene/ethylene-propylene copolymers, LDPElethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene/carbon monoxide copolymers and mixtures thereof with other polymers, for example polyamides.

The polymers are preferably hydrocarbon resins (e.g. C₅-C₉), including hydrogenated modifications thereof (e.g. tackifier resins) and mixtures of polyalkylenes and starch.

The polymers are preferably polystyrene (Polystyrol® 143E (BASF)), poly(p-methylstyrene), poly(alpha-methylstyrene).

The polymers are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; more impact-resistant mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylenelbutylene-styrene or styrene-ethylene/propylene-styrene.

The polymers are preferably graft copolymers of styrene or alpha-methylstyrene, for example styrene onto polybutadiene, styrene onto polybutadiene-styrene or polybutadiene-acrylonitrile copolymers, styrene and acrylonitrile (or methacrylonitrile) onto polybutadiene; styrene, acrylonitrile and methyl methacrylate onto polybutadiene; styrene and maleic anhydride onto polybutadiene; styrene, acrylonitrile and maleic anhydride or maleimide onto polybutadiene; styrene and maleimide onto polybutadiene, styrene and alkyl acrylates or alkyl methacrylates onto polybutadiene, styrene and acrylonitrile onto ethylene-propylene-diene terpolymers, styrene and acrylonitrile onto polyalkyl acrylates or polyalkyl methacrylates, styrene and acrylonitrile onto acrylate-butadiene copolymers, and mixtures thereof, as known, for example, as ABS, MBS, ASA or AES polymers.

The polymers are preferably halogenated polymers, for example polychloroprene, chlorine rubber, chlorinated and brominated copolymer of isobutylene-isoprene (halobutyl rubber), chlorinated or chlorosulfonated polyethylene, copolymers of ethylene and chlorinated ethylene, epichlorohydrin homo- and copolymers, especially polymers of halogenated vinyl compounds, for example polyvinyl chloride, polyvinylidene chloride, polyvinyl fluoride, polyvinylidene fluoride; and copolymers thereof, such as vinyl chloride-vinylidene chloride, vinyl chloride-vinyl acetate or vinylidene chloride-vinyl acetate.

The polymers are preferably polymers which derive from alpha,beta-unsaturated acids and derivatives thereof, such as polyacrylates and polymethacrylates, polymethyl methacrylates, polyacrylamides and polyacrylonitriles impact-modified with butyl acrylate, and copolymers of the monomers mentioned with one another or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

The polymers are preferably polymers which derive from unsaturated alcohols and amines or the acyl derivatives or acetals thereof, such as polyvinyl alcohol, polyvinyl acetate, stearate, benzoate or maleate, polyvinyl butyral, polyallyl phthalate, polyallylmelamine; and copolymers thereof with olefins.

The polymers are preferably homo- and copolymers of cyclic ethers, such as polyalkylene glycols, polyethylene oxide, polypropylene oxide or copolymers thereof with bisglycidyl ethers.

The polymers are preferably polyacetals such as polyoxymethylene, and those polyoxymethylenes which contain comonomers, for example ethylene oxide; polyacetals which have been modified with thermoplastic polyurethanes, acrylates or MBS.

The polymers are preferably polyphenylene oxides and sulfides and mixtures thereof with styrene polymers or polyamides.

The polymers are preferably polyurethanes which derive from polyethers, polyesters and polybutadienes having both terminal hydroxyl groups and aliphatic or aromatic polyisocyanates, and the precursors thereof.

The polymers are preferably polyamides and copolyamides which derive from diamines and dicarboxylic acids and/or from aminocarboxylic acids or the corresponding lactams, such as nylon 2/12, nylon 4 (poly-4-aminobutyric acid, Nylon® 4, from DuPont), nylon 4/6 (poly(tetramethyleneadipamide), Nylon® 4/6, from DuPont), nylon 6 (polycaprolactam, poly-6-aminohexanoic acid, Nylon® 6, from DuPont, Akulon K122, from DSM; Zytel® 7301, from DuPont; Durethan® B 29, from Bayer), nylon 6/6 (poly(N,N′-hexamethyleneadipamide), Nylon® 6/6, from DuPont, Zytel® 101, from DuPont; Durethan A30, Durethan® AKV, Durethan® AM, from Bayer; Ultramid® A3, from BASF), nylon 6/9 (poly(hexamethylenenonanamide), Nylon® 6/9, from DuPont), nylon 6/10 (poly(hexamethylenesebacamide), Nylon® 6/10, from DuPont), nylon 6/12 (poly(hexamethylenedodecanediamide), Nylon® 6/12, from DuPont), nylon 6/66 (poly(hexamethyleneadipamide-co-caprolactam), Nylon® 6/66, from DuPont), nylon 7 (poly-7-aminoheptanoic acid, Nylon® 7, from DuPont), nylon 7,7 (polyheptamethylenepimelamide, Nylon® 7,7, from DuPont), nylon 8 (poly-8-aminooctanoic acid. Nylon® 8, from DuPont), nylon 8,8 (polyoctamethylenesuberamide, Nylon® 8,8, from DuPont), nylon 9 (poly-9-aminononanoic acid, Nylon® 9, from DuPont), nylon 9,9 (polynonamethyleneazelamide, Nylon® 9,9, from DuPont), nylon 10 (poly-10-aminodecanoic acid, Nylon® 10, from DuPont), nylon 10,9 (poly(decamethyleneazelamide), Nylon® 10,9, from DuPont), nylon 10,10 (polydecamethylenesebacamide, Nylon® 10,10, from DuPont), nylon 11 (poly-11-aminoundecanoic acid, Nylon® 11, from DuPont), nylon 12 (polylauryllactam, Nylon® 12, from DuPont, Grillamid® L20, from Ems Chemie), aromatic polyamides proceeding from m-xylene, diamine and adipic acid; polyamides prepared from hexamethylenediamine and iso- and/or terephthalic acid (polyhexamethyleneisophthalamide, polyhexamethyleneterephthalamide) and optionally an elastomer as a modifier, e.g. poly-2,4,4-trimethylhexamethyleneterephthalamide or poly-m-phenyleneisophthalamide. Block copolymers of the aforementioned polyamides with polyolefins, olefin copolymers, ionomers or chemically bonded or grafted elastomers; or with polyethers, for example with polyethylene glycol, polypropylene glycol or polytetramethylene glycol. In addition, polyamides or copolyamides modified with EPDM (ethylene-propylene-diene rubber) or ABS (acrylonitrile-butadiene-styrene); and polyamides condensed during processing (“RIM polyamide systems”).

The polymers are preferably polyureas, polyimides, polyamidimides, polyetherimides, polyesterimides, polyhydantoins and polybenzimidazoles.

The polymers are preferably polyesters which derive from dicarboxylic acids and dialcohols and/or from hydroxycarboxylic acids or the corresponding lactones, such as polyethylene terephthalate, polybutylene terephthalate (Celanex® 2500, Celanex® 2002, from Celanese; Ultradure, from BASF), poly-1,4-dimethylolcyclohexane terephthalate, polyhydroxybenzoates, and block polyether esters which derive from polyethers with hydroxyl end groups; and also polyesters modified with polycarbonates or MBS.

The polymers are preferably polycarbonates and polyester carbonates.

The polymers are preferably polysulfones, polyether sulfones and polyether ketones.

Preferably, the polymers are crosslinked polymers which derive from aldehydes on the one hand, and phenols, urea or melamine on the other hand, such as phenol-formaldehyde, urea-formaldehyde and melamine-formaldehyde resins.

The polymers are preferably drying and nondrying alkyd resins.

The polymers are preferably unsaturated polyester resins which derive from copolyesters of saturated and unsaturated dicarboxylic acids with polyhydric alcohols, and vinyl compounds as crosslinking agents, and also the halogenated, flame-retardant modifications thereof.

The polymers preferably comprise crosslinkable acrylic resins which derive from substituted acrylic esters, for example from epoxy acrylates, urethane acrylates or polyester acrylates.

Preferably, the polymers are alkyd resins, polyester resins and acrylate resins which have been crosslinked with melamine resins, urea resins, isocyanates, isocyanurates, polyisocyanates or epoxy resins.

The polymers are preferably crosslinked epoxy resins which derive from aliphatic, cycloaliphatic, heterocyclic or aromatic glycidyl compounds, for example products of bisphenol A diglycidyl ethers, bisphenol F diglycidyl ethers, which are crosslinked by means of customary hardeners, for example anhydrides or amines, with or without accelerators.

The polymers are preferably mixtures (polyblends) of the abovementioned polymers, for example PP/EPDM (polypropylene/ethylene-propylene-diene rubber), polyamide/EPDM or ABS (polyamide/ethylene-propylene-diene rubber or acrylonitrile-butadiene-styrene), PVC/EVA (polyvinyl chloride/ethylene-vinyl acetate), PVC/ABS (polyvinyl chloride/acrylonitrile-butadiene-styrene), PVC/MBS (polyvinyl chloride/methacrylate-butadiene-styrene), PC/ABS (polycarbonate/acrylonitrile-butadiene-styrene), PBTP/ABS (polybutylene terephthalate/acrylonitrile-butadiene-styrene), PC/ASA (polycarbonate/acrylic ester-styrene-acrylonitrile), PC/PBT (polycarbonate/polybutylene terephthalate), PVC/CPE (polyvinyl chloride/chlorinated polyethylene), PVC/acrylate (polyvinyl chloride/acrylate), POM/thermoplastic PUR (polyoxymethylene/thermoplastic polyurethane), PC/thermoplastic PUR (polycarbonate/thermoplastic polyurethane), POM/acrylate (polyoxymethylene/acrylate), POM/MBS (polyoxymethylene/methacrylate-butadiene-styrene), PPO/HIPS (polyphenylene oxide/high-impact polystyrene), PPO/PA 6,6 (polyphenylene oxide/nylon 6,6) and copolymers, PA/HDPE (polyamide/high-density polyethylene), PA/PP (polyamide/polyethylene), PA/PPO (polyamide/polyphenylene oxide), PBT/PC/ABS (polybutylene terephthalate/polycarbonate/acrylonitrile-butadiene-styrene) and/or PBT/PET/PC (polybutylene terephthalate/polyethylene terephthalate/polycarbonate).

The polymers may be laser-markable.

The molding produced is preferably of rectangular shape with a regular or irregular base, or of cubic shape, cuboidal shape, cushion shape or prism shape.

The invention is illustrated by the examples which follow.

Production, processing and testing of flame-retardant polymer molding compositions and flame-retardant polymer moldings

The flame-retardant components are mixed with the polymer pellets and any additives and incorporated in a twin-screw extruder (model: Leistritz LSMI 30/34) at temperatures of 230 to 260° C. (PBT-GR) or of 260 to 280° C. (PA 66-GR). The homogenized polymer strand was drawn off, cooled in a water bath and then pelletized.

After sufficient drying, the molding compositions were processed on an injection molding machine (model: Aarburg Allrounder) at melt temperatures of 240 to 270° C. (PBT-GR) or of 260 to 290° C. (PA 66-GR) to give test specimens. The test specimens are tested for flame retardancy and classified using the UL 94 test (Underwriter Laboratories).

Test specimens of each mixture were used to determine the UL 94 fire class on specimens of thickness 1.5 mm.

The UL 94 fire classifications are as follows:

V-0: afterflame time never longer than 10 sec., total of afterflame times for 10 flame applications not more than 50 sec., no flaming drops, no complete consumption of the specimen, afterglow time for specimens never longer than 30 sec. after end of flame application

V-1: afterflame time never longer than 30 sec. after end of flame application, total of afterflame times for 10 flame applications not more than 250 sec., afterglow time for specimens never longer than 60 sec. after end of flame application, other criteria as for V-0

V-2: cotton indicator ignited by flaming drops, other criteria as for V-1.

Not classifiable (ncl): does not fulfill fire class V-2.

For some samples examined, the LOI was also measured. The LOI (Limiting Oxygen Index) is determined to ISO 4589. According to ISO 4589, the LOI corresponds to the lowest oxygen concentration in percent by volume which just still supports the combustion of the polymer in a mixture of oxygen and nitrogen. The higher the LOI the greater the nonflammability of the material tested.

| | | |
|---|---|---|
| LOI | 23 | flammable |
| LOI | 24-28 | limited flammability |
| LOI | 29-35 | flame-retardant |
| LOI | >36 | particularly flame-retardant |

Chemicals and Abbreviations Used:

Phenol novolac: Bakelite® PF 0790, from Hexion

Initiator: Vazo® 67, from DuPont

In principle, the process according to the invention is executed in such a way that the reaction mixture is exposed to a relatively high acetylene flow rate of at least 12 l/h, preferably at least 18 l/h, under the given reaction conditions. After the acetylene has been passed through the reaction solution until conversion is adequate and a sufficient time for continued reaction, the acetylene feed is stopped and the workup is conducted under inert gas atmosphere, preferably nitrogen. For this purpose, the reaction mixture is preferably driven out of the apparatus with nitrogen and, after the reaction mixture has cooled, the solid formed is filtered off with suction, redispersed under a nitrogen atmosphere with a solvent, washed and dried in a vacuum drying cabinet at 80 to 180° C. for several hours.

### EXAMPLE 1 PREPARATION OF ETHYLPHOSPHINIC ACID

At room temperature, a three-neck flask with stirrer and jacketed coil condenser is initially charged with 5852 g of tetrahydrofuran and “degassed” while stirring and passing nitrogen through, and all further reactions are executed under nitrogen. Then 70 mg of tris(dibenzylideneacetone)dipalladium and 95 mg of 4,5-bis(diphenylphosphino)-9,9-dimethylxanthene are added and the mixture is stirred for a further 15 minutes, then 198 g of phosphinic acid in 198 g of water are added. The reaction solution is transferred into a 2 l Büchi reactor. While stirring the reaction mixture, the reactor is charged with ethylene to 2.5 bar and the reaction mixture is heated to 80° C. After 56 g of ethylene have been absorbed, the mixture is cooled to room temperature and free ethylene is burnt off.

The reaction mixture is freed from the solvent on a rotary evaporator at a maximum of 60° C. and 350-10 mbar, 300 g of demineralized water are added to the residue, and the mixture is stirred under nitrogen atmosphere at room temperature for 1 hour. The resulting residue is filtered and the filtrate is extracted with 200 ml of toluene. The aqueous phase is freed from the solvent on a rotary evaporator at a maximum of 60° C. and 250-10 mbar.

31P NMR (D₂O, coupled): doublet of multiplet, 36.7 ppm; ethylphosphinic acid.

### EXAMPLE 2

0.5 mol of ethylphosphinic acid (prepared according to example 1) is initially charged in n-butanol as a solvent and inertized with a nitrogen gas stream while stirring for 30 minutes and heated to 80° C. Acetylene is passed through the reaction solution at 18 l/h and 0.2 mol % of initiator is metered in over 3 hours, and the mixture is left to react a little longer. Thereafter, the acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 65%, 34.8 g of a mixture of ethylene-1,2-bis(ethylphosphinic acid) (99.9% by weight) and diethylphosphinic acid (0.1% by weight) are obtained.

### EXAMPLE 3

0.5 mol of ethylphosphinic acid (prepared according to example 1) is initially charged in n-butanol and inertized with a nitrogen gas stream while stirring for 30 minutes and heated to 85° C. Acetylene is passed through the reaction solution at 20 l/h, and 0.2 mol % of initiator is metered in over 2.5 hours. After a continued reaction period of 30 minutes, the acetylene feed is stopped and acetylene is driven out of the apparatus with nitrogen. After the reaction mixture has been cooled, the solid formed is filtered off with suction and redispersed with 75 g of acetone, washed and dried in a vacuum drying cabinet at 100° C. for 4 hours. In a yield of 65%, 34.9 g of a mixture of ethylene-1,2-bis(ethylphosphinic acid) (98% by weight) and diethylphosphinic acid (2% by weight) are obtained.

### EXAMPLE 4

0.5 mol of ethylphosphinic acid (prepared according to example 1) is initially charged in n-butanol as a solvent and inertized with a nitrogen gas stream while stirring for 30 minutes and heated to 90° C. Acetylene is passed through the reaction solution at 30 l/h, and 0.2 mol % of initiator is metered in over 2 hours. After a continued reaction period of 30 minutes, the acetylene feed is stopped and acetylene is driven out of the apparatus with nitrogen. After the reaction mixture has been cooled, the solid formed is filtered off with suction and redispersed with 75 g of acetone, washed and dried in a vacuum drying cabinet at 100° C. for 4 hours.

In a yield of 63%, 34.2 g of a mixture of ethylene-1,2-bis(ethylphosphinic acid) (90% by weight) and diethylphosphinic acid (10% by weight) are obtained.

### EXAMPLE 5

21.5 g of pure diethylphosphinic acid are added to the mixture of ethylene-1,2-bis(ethylphosphinic acid) (99.9% by weight) and diethylphosphinic acid (0.1% by weight) synthesized according to example 2, so as to obtain a mixture of 60% by weight of ethylene-1,2-bis(ethylphosphinic acid) and 40% by weight of diethylphosphinic acid. The aforementioned diethylphosphinic acid is prepared according to example 8 of EP-B-1544205, in which distillation is effected according to the “Addition of sulfuric acid” step therein, in order to obtain the pure diethylphosphinic acid, and there is thus no conversion to a salt of diethylphosphinic acid.

### EXAMPLE 6

34.8 g of pure diethylphosphinic acid are added to the mixture of ethylene-1,2-bis(ethylphosphinic acid) (99.9% by weight) and diethylphosphinic acid (0.1% by weight) synthesized according to example 2, so as to obtain a mixture of 50% by weight of ethylene-1,2-bis(ethylphosphinic acid) and 50% by weight of diethylphosphinic acid. The aforementioned diethylphosphinic acid is prepared according to example 8 of EP-B-1544205, in which distillation follows the “Addition of sulfuric acid” step therein, in order to obtain the pure diethylphosphinic acid, and there is thus no conversion to a salt of diethylphosphinic acid.

Method for Producing Polymer Moldings:

Production of Epoxy Resin Specimens

100 parts of the phosphorus-modified epoxy resin are mixed with a corresponding OH equivalent of phenol resin and heated to 150° C. This liquefies the components. The mixture is stirred gradually until a homogeneous mixture has formed and is allowed to cool to 130° C. Then 0.03 part 2-phenylimidazole is added and the mixture is stirred once again for 5-10 min. Thereafter, the mixture is poured warm into a dish and cured at 140° C. for 2 h and at 200° C. for 2 h.

Production of Epoxy Resin Laminate

100 parts phosphorus-modified epoxy resin are added to 63 parts acetone and 27 parts Dowanol PM, and the appropriate amount of phenol resin is added. The mixture is left to stir for 30 min and then 2-phenylimidazole is added. The amount of phenylimidazole should be chosen such that the gel time is 240 sec. Thereafter, the target viscosity (flow cup) should be established by further addition of solvent. Thereafter, the mixture is filtered through a 400 μm sieve in order to remove excess resin particles. Then the woven glass fabric (7628 type, 203 g/m²) is immersed into the solution until complete wetting of the fabric has taken place. The sample is cautiously pulled out of the mixture and excess resin is removed. Thereafter, the sample is cured stepwise in a drying cabinet at temperatures up to 165° C. for a short period, such that the solvent has been removed and the prepreg has been precrosslinked. The gel time of these prepregs should be checked. Eight prepregs are laminated and cured in a heated press. The resin content of the cured laminates is 30-50%.

The thermal expansion of the molding produced, a laminate, is determined to ASTM E831-06.

### EXAMPLE 7 (COMPARATIVE)

According to the general method for producing a polymer molding, 100% of a bisphenol A resin is used to produce a laminate.

### EXAMPLE 8

Pure ethylene-1,2-bis(ethylphosphinic acid) is obtained according to example 2 with subsequent washing of the product with organic solvents.

According to the general method for producing a polymer molding, a composition composed of 90% by weight of bisphenol A resin with hardener and catalyst and 10% by weight of ethylene-1,2-bis(ethylphosphinic acid) is used to produce a molding.

### EXAMPLE 9

First of all, diethylphosphinic acid is prepared according to example 8 of EP-B-1544205, in which the addition of the sulfuric acid is followed by distillation in order to obtain a pure diethylphosphinic acid.

According to the general method for producing a polymer molding, a composition composed of 90% by weight of bisphenol A resin with hardener and catalyst and 10% by weight of diethylphosphinic acid is used to produce a molding.

### EXAMPLE 10

According to the general method for producing a polymer molding, a composition composed of 90% by weight of bisphenol A resin with hardener and catalyst and 10% by weight of the inventive mixture of ethylene-1,2-bis(ethylphosphinic acid) and diethylphosphinic acid according to example 2 is used to produce a molding.

### EXAMPLE 11

According to the general method for producing a polymer molding, a composition composed of 90% by weight of bisphenol A resin with hardener and catalyst and 10% by weight of the inventive mixture of ethylene-1,2-bis(ethylphosphinic acid) and diethylphosphinic acid according to example 3 is used to produce a molding.

### EXAMPLE 12

According to the general method for producing a polymer molding, a composition composed of 90% by weight of bisphenol A resin with hardener and catalyst and 10% by weight of the inventive mixture of ethylene-1,2-bis(ethylphosphinic acid) and diethylphosphinic acid according to example 4 is used to produce a molding.

### EXAMPLE 13

According to the general method for producing a polymer molding, a composition composed of 90% by weight of bisphenol A resin with hardener and catalyst and 10% by weight of the inventive mixture of ethylene-1,2-bis(ethylphosphinic acid) and diethylphosphinic acid according to example 5 is used to produce a molding.

### EXAMPLE 14

According to the general method for producing a polymer molding, a composition composed of 90% by weight of bisphenol A resin with hardener and catalyst and 10% by weight of the inventive mixture of ethylene-1,2-bis(ethylphosphinic acid) and diethylphosphinic acid according to example 6 is used to produce a molding.

TABLE
Compositions of the polymer mixture and of the
mixtures used, and test results

| | Composition | Mixture of | | | |
|---|---|---|---|---|---|
| | of | ethylene-1,2-bis- | | | |
| | polymer | (ethylphosphinic acid)/ | Coefficient of | | |
| | system/ | diethylphosphinic | thermal expansion | | |
| | mixture | acid | 0°-100° [ppm/° C.] | | |
| Example | [% by weight] | [% by weight] | Z | X | Y |
| 7 | 100:0 | | 69 | 20 | 7 |
| 8 | 90:10 | 100:0 | 68 | 20 | 7 |
| 9 | 90:10 | 0:100 | 70 | 22 | 7 |
| 10 | 90:10 | 99.9:0.1 | 65 | 18 | 5 |
| 11 | 90:10 | 98:2 | 62 | 16 | 5 |
| 12 | 90:10 | 90:10 | 60 | 16 | 5 |
| 13 | 90:10 | 60:40 | 57 | 13 | 4 |
| 14 | 90:10 | 50:50 | 56 | 13 | 4 |

Compared to the pure laminate (example 7), there is a decrease in the values for the laminate comprising the inventive mixture of ethylene-1,2-bis(ethylphosphinic acid) and diethylphosphinic acid; thermal expansion is thus very low. An increase in the diethylphosphinic acid content brings about a further improvement.

Compared to the prior art (example 7), the inventive mixtures exhibit lower values for the coefficient of thermal expansion, meaning that the inventive products lead to lower expansion of the moldings produced and hence meet the demands on dimensional stability.

### EXAMPLE 15

Production of Polyester-Based Polymer Moldings:

a) Preparation of Phosphorus-Modified Polyethylene Terephthalate

1000 g of dimethyl terephthalate are transesterified with 720 ml of ethylene glycol and 230 mg of Mn(OCOCH₃)₄*4H₂O at temperatures of 170-220° C. under a nitrogen atmosphere. After the methanol has been separated out, 17.2 g of the inventive mixture from example 4 are added at 220° C. and, after addition of 350 mg of Sb₂O₃, the reaction vessel is heated further to 250° C. and a vacuum is applied simultaneously. The polymerization is effected at 0.2 mm Hg and 287° C. within 2 hours. The resulting product has a melting point of 240-244° C. and a phosphorus content of 0.5%, and is in the form of pellets.

b) Production of Polymer Moldings

The polymer pellets thus produced are mixed with any additives and they are incorporated in a twin-screw extruder (model: Leistritz LSM 30/34) at temperatures of 250 to 290° C. (PET-GR). The homogenized polymer strand was drawn off, cooled in a water bath and then pelletized.

After sufficient drying, the molding compositions were processed on an injection molding machine (model: Aarburg Allrounder) at melt temperatures of 250 to 300° C. (PET-GR) to give test specimens.

The UL 94 fire class and the LOI were determined on test specimens of thickness 1.6 mm. Moldings of thickness 1.6 mm result in V-0 and an LOI of 28%.

1.-20. (canceled)

21. A flame-retardant thermoplastic or thermoset polymer molding composition or polymer molding, film, filament or fiber comprising 0.5 to 50% by weight of a mixture of at least one diphosphinic acid of the formula (I) 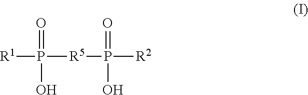
wherein
R¹, R² are the same or different and are H, C₂-C₁₈-alkenyl, C₆-C₁₈-aryl or C₇-C₁₈-alkylaryl,
R⁵ is C₁-C₁₈-alkylene, C₂-C₁₈-alkenylene, C₆-C₁₈-arylene or C₇-C₁₈-alkylarylene with at least one dialkylphosphinic acid of the formula (II) 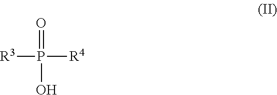
wherein
R³, R⁴ are the same or different and are C₁-C₁₈-alkyl, C₂-C₁₈-alkenyl, C₆-C₁₈-aryl, C₇-C₁₈-alkylaryl or mixtures thereof, 50 to 99.5% by weight of thermoplastic or thermoset polymer or mixtures thereof, 0 to 55% by weight of additives and 0 to 55% by weight of filler or a reinforcing material, where the sum of the components is 100% by weight.

22. A flame-retardant thermoplastic or thermoset polymer molding composition or polymer molding, film, filament or fiber comprising 2 to 30% by weight of a mixture of at least one diphosphinic acid of the formula (I) 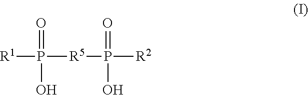
wherein
R¹, R² are the same or different and are H, C₂-C₁₈-alkenyl, C₆-C₁₈-aryl or C₇-C₁₈-alkylaryl,
R⁵ is C₁-C₁₈-alkylene, C₂-C₁₈-alkenylene, C₆-C₁₈-arylene or C₇-C₁₈-alkylarylene with at least one dialkylphosphinic acid of the formula (II) 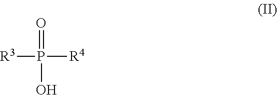
wherein
R³, R⁴ are the same or different and are C₁-C₁₈-alkyl, C₂-C₁₈-alkenyl, C₆-C₁₈-aryl, C₇-C₁₈-alkylaryl or mixtures thereof, 60 to 94% by weight of thermoplastic or thermoset polymer or mixtures thereof, 2 to 30% by weight of additives and 2 to 30% by weight of filler or a reinforcing material, where the sum of the components is 100% by weight.
